(19) United States
(12) Patent Application Publication
(10) Pub. No.: US 2008/0036297 A1
(43) Pub. Date: Feb. 14, 2008

(54) Imaging apparatus with transport system employing snap-on idler wheel

(76) Inventor: James R. Gilbertson, Oakdale, MN (US)

Correspondence Address: Carestream Health Inc,, 150 Verona Street, Rochester, NY, 14608, US

(21) Appl. No.: 11/502,095

(22) Filed: Aug. 10, 2006

(51) Int. Cl. B62D 55/14

(52) U.S. Cl. 305/136

(57) ABSTRACT

An idler wheel assembly including a shaft having a first diameter and including at least one circumferential groove, the shaft having second diameter less than the first diameter at the groove, and at least one idler wheel. The idler wheel includes a rim having an outside diameter greater than the first diameter and a split hub concentric with and coupled to the rim and having a normally circular shape with an inner diameter less than the first diameter and greater than the second diameter, wherein upon compression of the rim the split hub is configured to deflect from the normally circular shape such that the inner diameter of the split hub increases to exceed at least the first diameter to enable the split hub to be slid over the shaft to the groove, and upon removal of the compression to the rim, the split hub is configured to return to the normally circular shape such that the split hub fits into and is retained within the groove and is free to spin about the shaft.

### FIELD OF THE INVENTION

The present invention relates generally to an imaging apparatus, and more specifically to an imaging apparatus having a transport system with idler wheel assemblies employing snap-on idler wheels.

### BACKGROUND OF THE INVENTION

Light sensitive photothermographic film is used in many applications ranging from photocopying apparatuses to graphic arts to medical imaging systems. For example, laser imagers are widely employed in the field of medical imaging to produce visual representations on photothermographic film of digital image data generated by various scanners, such as magnetic resonance imaging (MRI) scanners and computed tomography (CT) scanners. Laser imagers typically include some type of film supply system, a film exposure system, a film processing system, and a transport system that moves and guides film through the laser imager along a transport path from the supply system and through the exposure and processing systems to an output.

Transport systems often employ a combination of driven spring-loaded roller pairs, stationary film guides, and non-driven rolling elements, such as idler wheels. Idler wheels are typically employed at locations along the transport path where roller pairs are unable to be used (due to space constraints, for example) and where stationary film guides may introduce scratches to the film.

Idler wheels are typically mounted on some type of stationary, or dead, shaft about which the idler wheels spin or rotate. Idler wheels are typically low-inertia so as to be easily spun and avoid scratching when contacted by the imaging media. One type of idler wheel assembly includes a dead shaft on which idler wheels are spaced in a fashion to support various widths of imaging media. Each idler wheel is held in position by a pair of clips, or e-rings, one on each side of the idler wheel, with each e-ring fitting into a corresponding groove machined into the dead shaft.

While such an idler wheel assembly is effective at guiding and transporting film, due to the large number of parts and machined grooves, it is relatively costly and time consuming to manufacture and assemble. For example, in one particular laser imager, eight such idler wheel assemblies are employed, each having six idler wheels. As such, each idler wheel assembly requires twelve e-rings and twelve machined grooves, for a total of ninety-six e-rings and corresponding machined grooves for the laser imager as a whole. In light of the above, there is a need for an improved idler wheel assembly.

### SUMMARY OF THE INVENTION

According to one aspect, the present invention provides an idler wheel assembly including a shaft having a first diameter and including at least one circumferential groove, the shaft having second diameter less than the first diameter at the groove, and at least one idler wheel. The idler wheel includes a rim having an outside diameter greater than the first diameter and a split hub concentric with and coupled to the rim and having a normally circular shape with an inner diameter less than the first diameter and greater than the second diameter, wherein upon compression of the rim the split hub is configured to deflect from the normally circular shape such that the inner diameter of the split hub increases to exceed at least the first diameter to enable the split hub to be slid over the shaft to the groove, and upon removal of the compression to the rim, the split hub is configured to return to the normally circular shape such that the split hub fits into and is retained within the groove and is free to spin about the shaft.

By employing an idler wheel having an integral split-hub which is expandable to slide over the shaft and snap into a corresponding groove on the shaft, an idler wheel assembly according to embodiments of the present invention includes fewer components, is easier to assemble, and is less costly than conventional idler wheel assemblies.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a block illustrating generally an imaging apparatus employing an idler wheel assembly according to embodiments of the present invention.

FIG. 2 is a perspective view illustrating one embodiment of an idler wheel assembly according to the present invention.

FIG. 3A is a cross-sectional view of a shaft employed by an idler wheel assembly according to the present invention.

FIG. 3B is a side view of a portion of a shaft employed by an idler wheel assembly according to the present invention.

FIG. 4 is a side view of one embodiment of an idler wheel according to the present invention.

FIG. 5 is a perspective view of the idler wheel of FIG. 4.

FIG. 6 is a side view illustrating the idler wheel of FIG. 4 in a compressed state.

FIG. 7A is a cross-sectional view of an idler wheel assembly according to the present invention illustrating an idler wheel being installed on a shaft.

FIG. 7B is a cross-sectional view of an idler wheel assembly according to the present invention illustrating an idler wheel after being installed on a shaft.

FIG. 8 illustrates generally portions of an imaging apparatus employing an idler wheel assembly according to embodiments of the present invention.

### DETAILED DESCRIPTION OF THE INVENTION

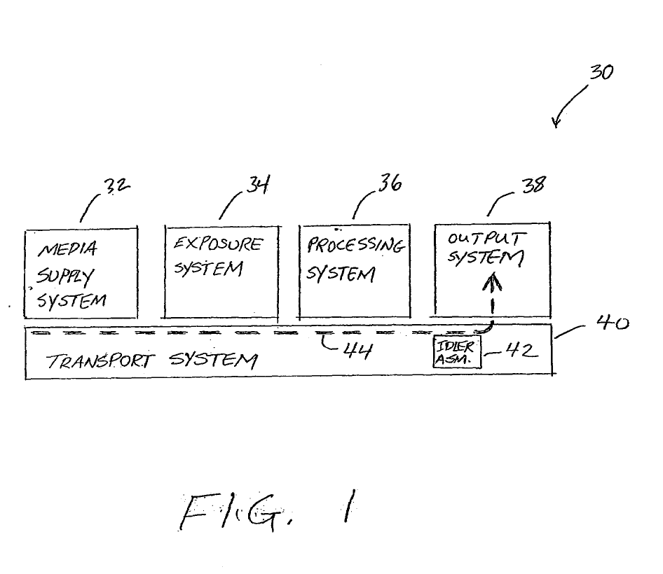

FIG. 1 is a block diagram illustrating generally an imaging apparatus 30 having a transport system employing an idler wheel assembly according to embodiments of the present invention. Imaging apparatus 30 includes a media supply system 32, an exposure system 34, a processing system 36, an output system 38, and a transport system 40. Transport system 40 includes at least one idler wheel assembly 42, according to embodiments of the present invention, which forms a portion of a transport path 44 along which transport system 40 moves sheets of imaging media (e.g. film) through imaging apparatus 30 from media supply system 32 to output system 38. In one embodiment, transport system 40 further includes driven roller pairs (not shown) that form a portion of transport path 44.

In operation, transport system 40 receives and moves a sheet of unexposed imaging media from media supply system 32 (including a film stack or film cartridge, for example) along transport path 44 to exposure system 34, which exposes a desired photographic image on the film based on image data representative of the desired photographic image (e.g. digital or analog) to form a latent image of the desired photographic image on the film. In one embodiment, exposure system 34 comprises a laser imager.

Transport system 40 moves the exposed film along transport path 44 from exposure system 34 to processing system 36 that develops the latent image in the exposed film. In one embodiment, processing system 36 comprises a thermal processing system, such as a drum-type processor, for example, which heats the exposed film to thermally develop the latent image. The developed film is cooled and moved along transport path 44 by transport system 40 to an output system 38, such as sorter, for example, for access by a user.

An example of an imaging apparatus similar to that described generally above by imaging apparatus 30 and suitable to be configured for use with idler wheel assembly 42 is describe by U.S. Pat. No. 6,007,971 to Star et al., which is herein incorporated by reference.

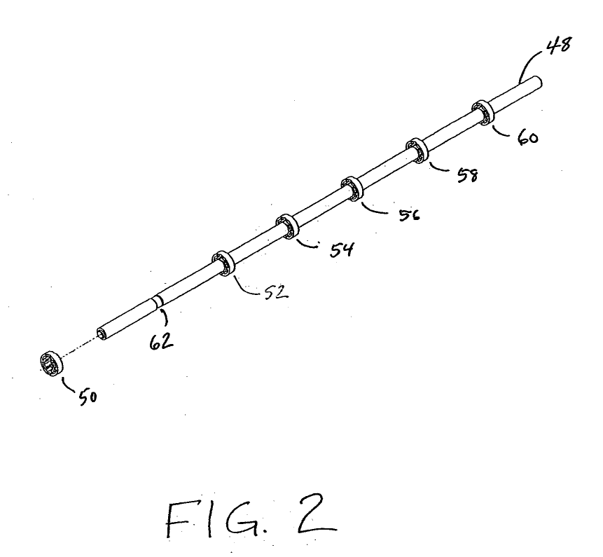

FIG. 2 is a perspective view illustrating one embodiment of idler wheel assembly 42 according to the present invention. Idler wheel assembly 42 includes a shaft 48 and a plurality of idler wheels, illustrated as idler wheels 50 through 60, with each idler wheel being retained within a corresponding circumferential groove on shaft 48, such as groove 62 corresponding to idler wheel 50. In one embodiment, as illustrated, idler wheels 50 through 60 are spaced along a length of shaft 48 in a fashion to accommodate and support imaging media of various widths.

In one embodiment, shaft 48 is mounted at each end to support structures (not illustrated) and extends across a width of transport path 44. As a sheet of imaging media moves along transport path 44, the sheet of imaging media contacts at least a portion of idler wheels 50-60. The contacted portion of idler wheels 50-60 support the sheet of imaging media and spin about shaft 48 as the imaging media moves downstream along transport path 44, such as to another idler wheel assembly or to a driven roller set (e.g. a drive roller and idler roller), for example. By spinning about shaft 48, idler wheels 50-60 are less likely to scratch or otherwise damage the imaging media than stationary film guides as the imaging media moves along transport path 44.

In FIG. 2, idler wheel 50 is shown in an uninstalled position. As will be described in greater detail below, idler wheel 50 includes a circular-shaped split inner hub which is configured to deflect from its normally circular shape and expand from a normal diameter when idler wheel 50 is compressed to enable idler wheel 50 to be placed on and slid over shaft 48 to corresponding groove 62. Upon reaching groove 62 and releasing a compressive force, the split hub returns to its circular shape and normal diameter and fits or “snaps” into and is retained by groove 62 in a fashion that allows idler wheel 50 to spin freely about shaft 48. By employing an idler wheel, such as idler wheel 50, having an integral split-hub which is expandable to slide over shaft 48 and snap into corresponding groove 62, idler wheel assembly 42 according to the present invention includes fewer components, is easier to assemble, and is less costly than conventional idler wheel assemblies.

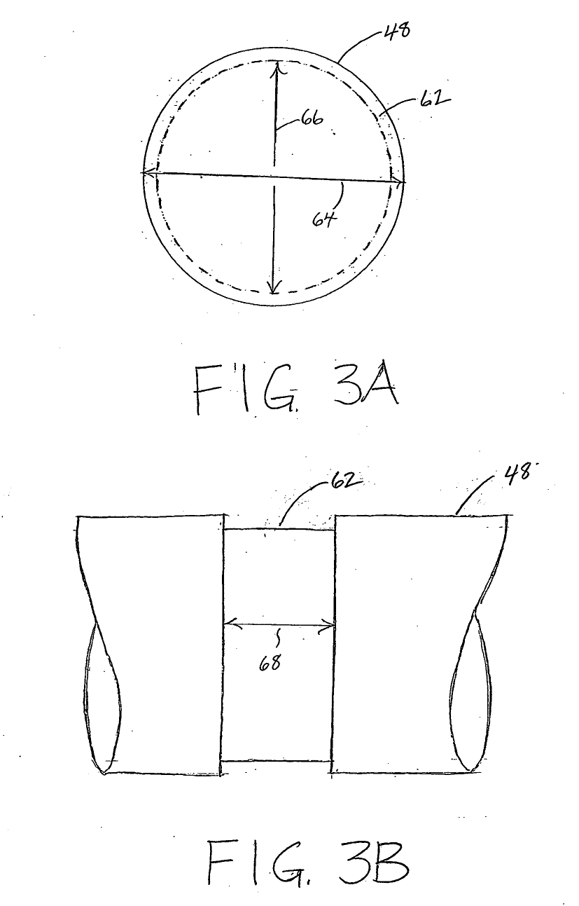

FIGS. 3A and 3B respectively illustrate cross-sectional and side views of shaft 48 of FIG. 2. With reference to FIG. 3A, the dashed line indicates a circumference of shaft 48 at groove 62. Shaft 48 has a first diameter 64 and a second diameter 66 at groove 62 that is less than first diameter 64. FIG. 3B illustrates a portion of shaft 48, including groove 62, which is indicated as having a width 68.

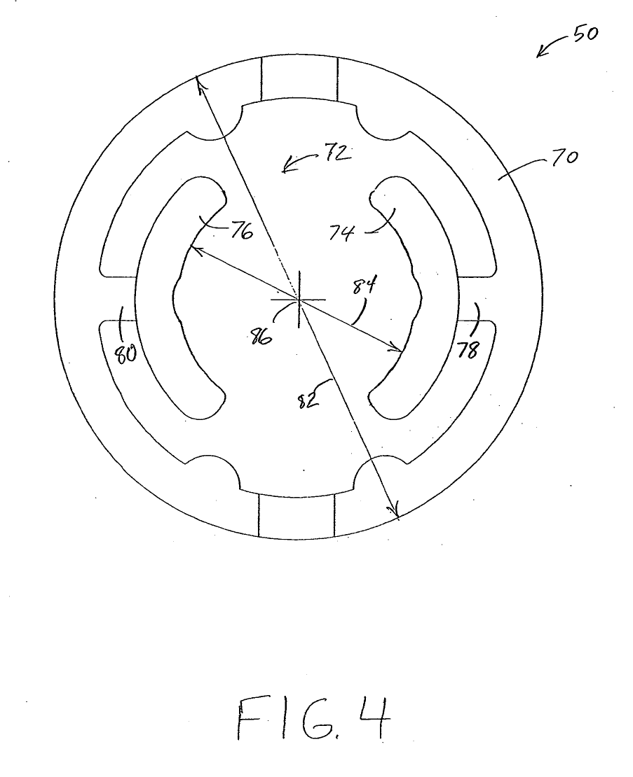

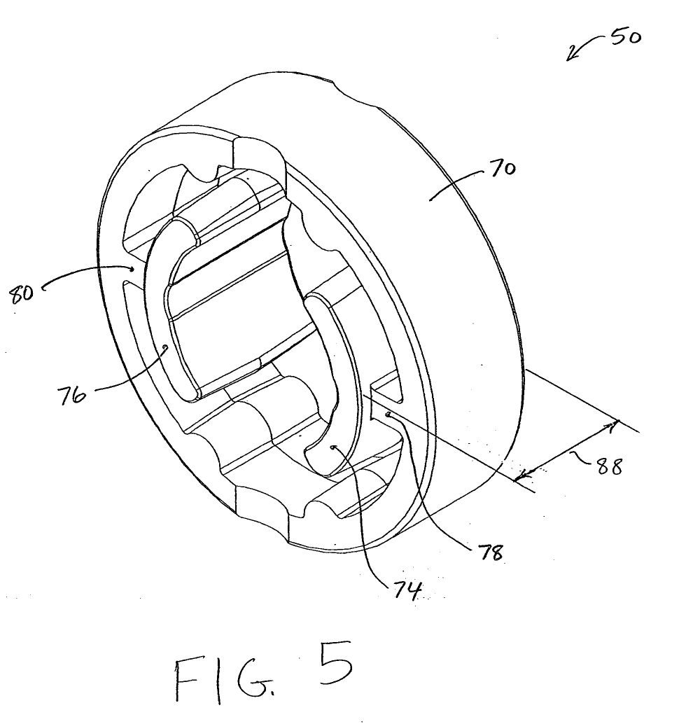

FIG. 4 is a side view of one embodiment of idler wheel 50. Idler wheel 50 includes an outer rim 70 and a concentric circular split-hub 72 formed by a semi-circular first hub segment 74 and a semi-circular second hub segment 76. First and second hub segments 74 and 76 are respectively coupled to and spaced from outer rim 70 by posts 78 and 80. As illustrated, first and second hub segments 74 and 76 are positioned radially opposite one another relative to a center 86 of idler wheel 50.

As mentioned above and as will be described in greater detail below, out rim 70 and split-hub 72 are configured to deflect from their normally circular shapes upon application of a compressive force to outer rim 70. In FIG. 4, idler wheel 50 is shown in a normal or non-compressed state, with outer rim 70 having an outer diameter 82 and split hub 72 having an inner diameter 84, each diameter being relative to center 86. With reference to FIGS. 3A and 3B, outer diameter 82 of outer rim 70 is greater than first diameter 64 of shaft 48. In one embodiment, for example, outer rim 70 has an outer diameter 82 of approximately 16.93 millimeters.

Split hub 72 is configured to provide a “running fit” with respect to shaft 48, with inner diameter 84 of split hub 72 being less than first diameter 64 and greater than second diameter 66 of shaft 48 at groove 62 such that idler wheel 50 is able freely rotate about shaft 48 without “wobbling.” In one embodiment, for example, second diameter 66 of shaft 48 at groove 62 has a diameter ranging substantially between 8.08 and 8.12 millimeters (mm) and inner diameter 84 of split hub 72 has a diameter ranging substantially between 8.17 and 8.27 mm so that split hub 72 has a clearance relative to shaft 48 ranging from a minimum of 0.05 mm to a maximum of 0.19 mm.

FIG. 5 is a perspective view of idler wheel 50 of FIG. 4. As illustrated, outer rim 70 and first and second hub segments 74 and 76 have a width 88, which is less than width 68 of groove 62 (see FIG. 3B). In one embodiment, first and second hub segments 74 and 76 have a width greater than a width on 30 outer rim 70. In one embodiment, width 88 is incrementally less than width 68 of groove 62 so that idler wheel 50 is free to rotate about shaft 48 within groove 62 with substantially no lateral movement of idler wheel 50 relative to shaft 48. In one embodiment, for example, width 88 of first and second hub segments 74 and 76 ranges substantially between 5.87 and 6.13 mm and width 68 of groove 62 ranges substantially between 6.26 and 6.46 mm so that split hub 72 has a clearance relative to groove 62 ranging from a minimum of 0.13 mm to a maximum of 0.59 mm.

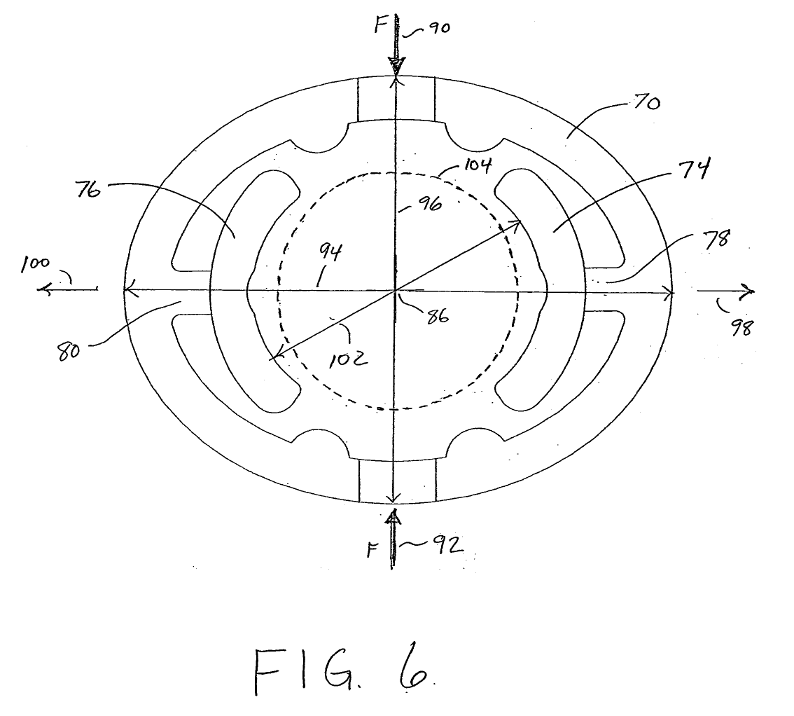

As mentioned above, outer rim 70 is configured to be compressible so as to cause split hub 72 to deflect from its normally circular shape and expand in diameter from normal inner diameter 88. FIG. 6 is a side view illustrating idler wheel 50 in a compressed state in response to compression forces 90 and 92 being applied to outer rim 70. As illustrated, in response to compression forces 90 and 92, outer rim 70 deflects from its normally circular shape to an elliptical shape having a major axis 94 and a minor axis 96 which are respectively greater than and less than the normal outer diameter 82 of outer rim 70 (see FIG. 4). In FIG. 6, it is noted that compression forces 90 and 92 are applied along an axis perpendicular to an axis along which posts 78 and 80 are positioned.

As compression forces 90 and 92 are applied, outer rim 70 deflects from its normally circular shape causing first hub segment 74 and post 78 and second hub segment 76 and post 80 to move in radially opposite directions away from idler wheel center 86, as indicated respectively by directional arrows 98 and 100. As a result, split hub 72 deflects from its normally circular shape, with the “diameter” of split hub 72 expanding such that a distance 102 between any two radially opposite points on the inner surfaces of first and second hub elements 74 and 76 is greater than the first diameter 64 of shaft 48. For reference, the normal circumference of split hub 72 formed by first and second hub segments 74 and 76 when in a non-compressed state is illustrated by the dashed line at 104. By expanding in this fashion when compression forces 90 and 92 are applied to outer rim 70, split hub 72 can be placed on and slid over shaft 48 to groove 62.

As described above, idler wheel 50 is configured to be compressible so as to enable split hub 72 to expand be slid over shaft 48 and snap into groove 62. As such, in one embodiment, idler wheel 50 comprises an elastic material. In one embodiment, idler wheel 50 comprises a plastic material. In one embodiment, rim 70, first and second hub segments 74 and 76, and post 78 and 80 are formed from a contiguous piece of material. In one embodiment, idler wheel 50 is configured so that outer rim 70 can be readily compressed to deflect and enable split hub 72 to deflect and receive shaft 48, but with sufficient elastic recovery such that outer rim 70 and split hub 72 return to and retain their original shape so that idler wheel 50 is captured within and retained by groove 62 on shaft 48.

During transport of imaging media along transport path 44, idler wheel 50 supports the imaging media and spins about shaft 48 as the imaging media passes. In one embodiment, in order to prevent static build-up on the imaging media as it passes over idler 50, idler wheel 50 comprises a low- or anti-static material. In one embodiment, idler wheel 50 comprises anti-static acetal.

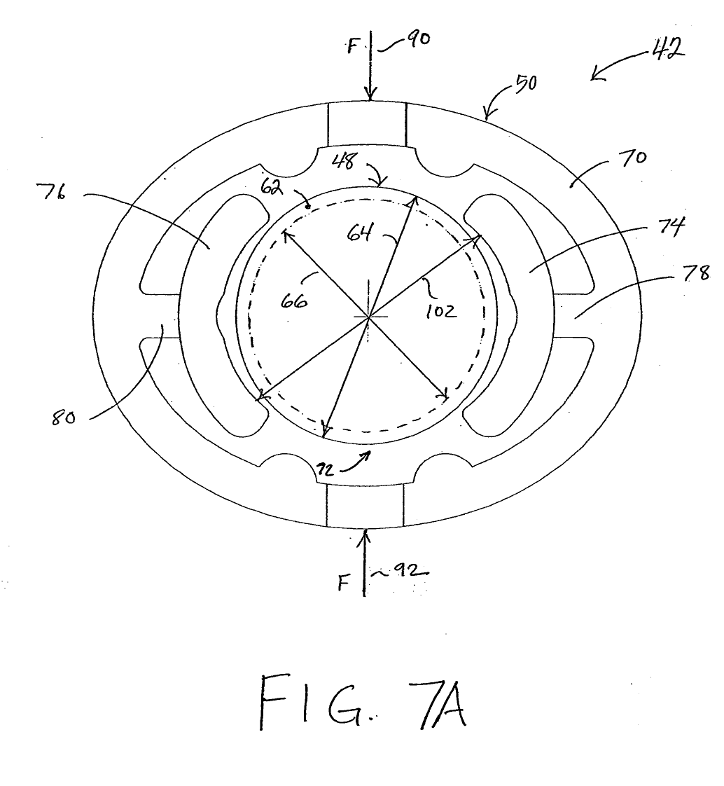

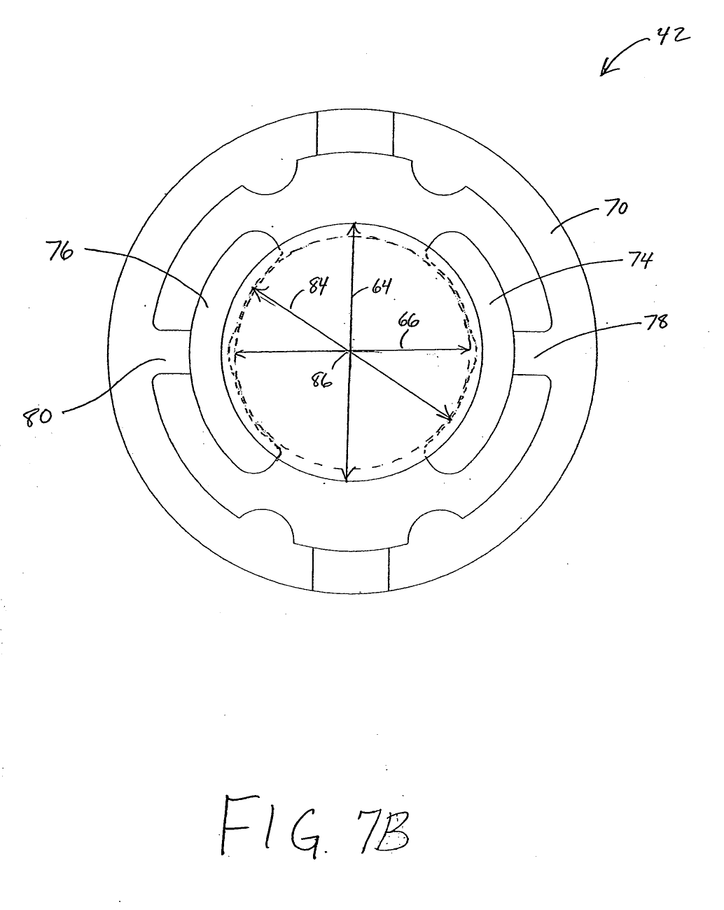

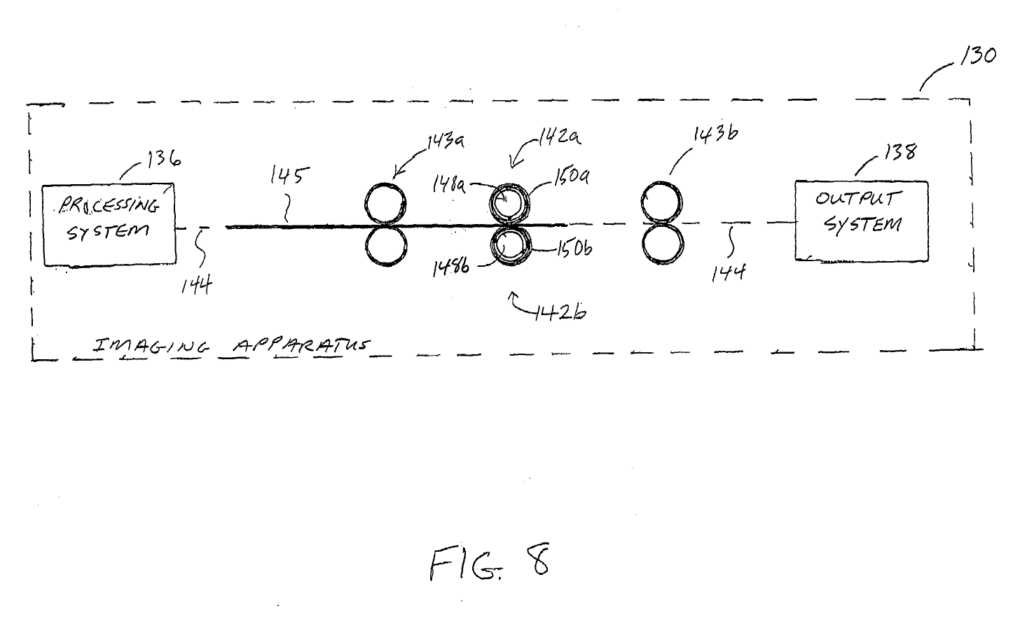

FIGS. 7A and 7B illustrate the process of installing idler wheel 50 on shaft 48. FIG. 7A illustrates idler wheel 50 in a compressed state caused by application of compression forces 90 and 92. As shown in FIG. 7A, outer rim 70 has deflected, causing split hub 72 to deflect and expand so that distance 102 between radially opposite points of first and second hub elements 74 and 76 exceeds first diameter 64 of shaft 48. Split hub 72 is then placed over and slid on shaft 48 to groove 62. As illustrated by FIG. 7B, upon reaching groove 62, compression forces 90 and 92 are released and outer rim 70 and split hub 72 return to their normal circular shapes with and first and second hub elements 74 and 76 “snapping” into groove 62. As illustrated, inner diameter 84 of split hub 72 is less than first diameter 64 and incrementally greater than second diameter 66 at groove 62, thereby causing split hub 72 to be retained by groove 62 but with idler wheel 50 free to spin about shaft 48.

FIG. 8 illustrates generally an imaging apparatus 130 employing idler wheel assemblies in accordance with the present invention, illustrated as idler wheel assemblies 142a and 142b and having corresponding idler wheels 150a and 150b positioned on shafts 148a and 148b. As illustrated, idler wheel assemblies 142a and 142b, together with two sets of driven roller pairs 143a and 143b, form a transport path 144 between a processing system 136 (e.g. a thermal processor) and an output system 138 (e.g. a tray). In the illustrated example, driven roller pairs 143a and 143b drive a sheet of imaging media 145 along transport path 144, with idler wheel assemblies 142a and 142b being positioned between driven roller pairs 143a and 143b. As imaging media 145 passes through a nip formed by idler wheel assemblies 143a and 143b, idler wheels 150a and 150b rotate about respective shafts 148a and 148b and direct imaging media 145 from driven roller pair 143a to driven roller 143b along transport path 144. Although illustrated in a nip configuration, idler wheel assemblies according to embodiments of the present invention, such as idler wheel assemblies 143a and 143b, may be employed in any number of configurations and be positioned at any number locations within an imaging apparatus, such as imaging apparatus 130.

The invention has been described in detail with particular reference to certain preferred embodiments thereof, but it will be understood that variations and modifications can be effected within the spirit and scope of the invention.

### PARTS LIST

30 Imaging Apparatus

32 Media Supply System

34 Exposure System

36 Processing System

38 Output System

40 Transport System

42 Idler Wheel Assembly

44 Transport Path

48 Shaft

50 Idler Wheel

52 Idler Wheel

54 Idler Wheel

56 Idler Wheel

58 Idler Wheel

60 Idler Wheel

62 Groove

64 First Diameter of Shaft

66 Second Diameter of Shaft (at Groove 62)

68 Groove Width

70 Outer Rim

72 Split Hub

74 First Hub Segment

76 Second Hub Segment

78 Post

80 Post

82 Outer Diameter of Outer Rim 70

84 Inner Diameter of Split Hub 72

86 Center of Idler Wheel 50

88 Width of First and Second Hub Segments 74, 76

90 Compression Force

92 Compression Force

94 Major Axis of Deflected Idler Wheel 50

96 Minor Axis of Deflected Idler Wheel 50

98 Directional Arrow

100 Directional Arrow

102 Distance Between Deflected First and Second Hub Segments 74, 76

104 Non-Deflected Circumference of Split Hub 72

130 Imaging Apparatus

136 Processing System

138 Output System

142 Idler Wheel Assemblies (142a, 142b)

143 Driven Roller Pair (143a, 143b)

144 Transport Path

145 Imaging Media

148 Shafts (148a, 148b)

150 Idler Wheels (150a, 150b)

What is claimed is:

1. An idler wheel assembly comprising:
a shaft having a first diameter and including at least one circumferential groove, the shaft having second diameter less than the first diameter at the groove; and
at least one idler wheel including:
a rim having an outside diameter greater than the first diameter, and
a split hub concentric with and coupled to the rim and having a normally circular shape with an inner diameter less than the first diameter and greater than the second diameter, wherein upon compression of the rim the split hub is configured to deflect from the normally circular shape such that the inner diameter of the split hub increases to exceed at least the first diameter to enable the split hub to be slid over the shaft to the groove, and upon removal of the compression to the rim, the split hub is configured to return to the normally circular shape such that the split hub fits into and is retained within the groove and is free to spin about the shaft.

2. The idler wheel assembly of claim 1, wherein the split hub has an inner diameter relative to the second diameter and a width relative to a width of the groove configured to provide the split hub with a running fit when positioned in the groove.

3. The idler wheel assembly of claim 2, wherein the inner diameter of the split hub has a clearance relative to the second diameter ranging approximately between 0.05 millimeter and 0.20 millimeters.

4. The idler wheel assembly of claim 1, wherein the idler wheel comprises an elastic material.

5. The idler wheel assembly of claim 1, wherein the idler wheel comprises a material which enables the idler wheel to sufficiently compress such that the inner diameter of the split hub expands so as to at least be greater than the first diameter of the shaft and with an elastic recovery sufficient to enable the split hub and rim to substantially return to their normally circular shapes.

6. The idler wheel assembly of claim 1, wherein the idler wheel comprises a plastic material.

7. The idler wheel assembly of claim 1, wherein the idler wheel comprises a material having low static properties.

8. The idler wheel assembly of claim 1, wherein the idler wheel comprises a contiguous structure formed from a contiguous piece of material.

9. The idler wheel assembly of claim 1, wherein the idler wheel comprises an anti-static acetal material.

10. The idler wheel assembly of claim 1, including a plurality of idler wheels, each idler wheel having a corresponding groove in the shaft, wherein the idler wheels and corresponding grooves are spaced along the shaft so as to support imaging media of various widths.

11. The idler wheel assembly of claim 1, wherein the split hub comprises a first and second hub segment, each being semi-circular in shape and each being coupled to the outer rim by a corresponding post, wherein the first and second hub segments form portions of a circle having the inner diameter.

12. An idler wheel suitable for conveying imaging media in an imaging apparatus, the idler wheel comprising:
an outer rim having a normally circular shape, the outer rim configured to deflect its normally circular shape upon application of compressive forces and to substantially return to its normally circular shape upon release of the compressive forces, and
a split hub concentric with and coupled to the rim and having an inner surface forming a normally circular shape having a desired diameter, wherein upon application of the compressive forces to the outer rim the split hub is configured to deflect its normally circular shape such that a distance between radially opposite points on the inner surface increases from the desired diameter to a desired distance, and upon release of the compressive forces configured to configured to substantially return to its normally circular shape and desired diameter.

13. The idler wheel of claim 12, wherein the split hub comprises a first and second hub segment, each being semi-circular in shape and each being coupled to the outer rim by a corresponding post, wherein the first and second hub segments form portions of a circle having the inner diameter.

14. The idler wheel of claim 13, wherein the first and second hub segments are coupled to opposite sides of the rim along a first axis, and wherein the compressive forces comprise an opposing pair of forces applied to opposite sides of the rim along a second axis which is perpendicular to the first axis.

15. The idler wheel of claim 12, wherein the idler wheel comprises an elastic material.

16. The idler wheel of claim 15, wherein the idler wheel comprises a material which enables the idler wheel to sufficiently compress such that the inner diameter of the split hub expands to at least be greater than the first diameter of the shaft and with an elastic recovery sufficient to enable the split hub and rim to substantially return to their normally circular shapes.

17. The idler wheel of claim 12, wherein the idler wheel comprises a plastic material.

18. The idler wheel of claim 12, wherein the idler wheel comprises a material having low static properties.

19. The idler wheel of claim 12, wherein the idler wheel comprises an anti-static acetal material.

20. A method of assembling an idler wheel assembly suitable for use in an imaging apparatus, the method comprising:
providing a shaft having a first diameter and including a groove having a second diameter which is less than the first diameter;
applying compressive forces to an idler wheel having an inner split hub with a normally circular shape with an inner diameter greater than the second diameter and less than the first diameter so that the split hub deflects from its normally circular shape such that inner diameter expands to exceed at least the first diameter;
sliding the split hub onto and across the shaft to the groove; and
releasing the compressive forces so that the inner hub returns to the normally circular shape such that the split hub snaps into with groove and the idler wheel is free to rotate about the shaft.

21. An imaging apparatus for producing a desired image on an imaging media, the imaging apparatus including a media transport system employing an idler wheel assembly comprising:
a shaft having a first diameter and including at least one circumferential groove, the shaft having second diameter less than the first diameter at the groove; and
at least one idler wheel including:
a rim having an outside diameter greater than the first diameter, and
a split hub concentric with and coupled to the rim and having a normally circular shape with an inner diameter less than the first diameter and greater than the second diameter, wherein upon compression of the rim the split hub is configured to deflect from the normally circular shape such that the inner diameter of the split hub increases to exceed at least the first diameter to enable the split hub to be slid over the shaft to the groove, and upon removal of the compression to the rim, the split hub is configured to return to the normally circular shape such that the split hub fits into and is retained within the groove and is free to spin about the shaft.
